(19) United States
(12) Patent Application Publication
(10) Pub. No.: US 2008/0239737 A1
(43) Pub. Date: Oct. 2, 2008

(54) Headlight Apparatus and Vehicle

(75) Inventor: Yasushi AOKI, Samutprakarn (TH)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 11/860,425

(22) Filed: Sep. 24, 2007

(30) Foreign Application Priority Data
Sep. 29, 2006 (JP) 2006-269999

(51) Int. Cl. B62J 6/00

(52) U.S. Cl. 362/475

(57) ABSTRACT

A headlight apparatus that adjusts the luminous energy and traveling direction of light emitted from a flasher bulb without applying a machining on an inner surface of a flasher lens. A headlight unit includes a flasher bulb that flashes at predetermined intervals, and a flasher lens. The headlight unit has a louver that partitions the flasher lens. The louver is disposed on an inner surface of the flasher lens.

### RELATED APPLICATIONS

This application claims the benefit of priority under 35 USC 119 of Japanese patent application nos. 2006-269999, filed on Sep. 29, 2006, which application is hereby incorporated by reference in its entirety.

### BACKGROUND OF THE INVENTION

1. Field of the Invention

The present invention relates to a headlight apparatus having a headlight and a directional indicator, and to a vehicle having the headlight apparatus.

2. Description of Related Art

A headlight apparatus is provided in a front portion of a vehicle, such as a motorcycle, e.g., in front of a handlebar.

In known configurations, a directional indicator, or a flasher lamp, is disposed on each outer side of a headlight to indicate a change in traveling direction of the vehicle (see, e.g., JP-Y-2547379 (page 3 and FIG. 1)).

A flasher lamp of this type generally has a flasher bulb that flashes at predetermined intervals and a flasher lens disposed forward of the flasher bulb. Predetermined projections and depressions are formed on an inner surface of the flasher lens to adjust the luminous energy and a traveling direction of light emitted from the flasher bulb.

The aforementioned conventional headlight apparatus has a problem in that the flasher lens must be thicker than a predetermined thickness to allow the predetermined projections and depressions to be formed on the inner surface of the lens. Therefore, the ability to reduce the thickness of the flasher lens in order to reduce the weight of the headlight apparatus is limited.

Furthermore, there is another problem in that the process of forming the predetermined projections and depressions on the inner surface of the flasher lens is complicated and increases manufacturing costs.

### SUMMARY OF THE INVENTION

The present invention has been conceived in view of the above circumstances, and provides a headlight apparatus for a vehicle that allows adjustment of luminous energy and a traveling direction of light emitted from a flasher bulb without applying a work on an inner surface of a flasher lens.

A first aspect of the invention is a headlight apparatus that has a headlight and a directional indicator. The directional indicator includes a light source that flashes at predetermined intervals, and a directional indicator lens disposed forward of the light source. A partition disposed on an inner surface of the directional indicator lens partitions the directional indicator lens.

According to the invention, the partition that partitions the directional indicator lens is disposed on the inner surface of the directional indicator lens. Hence, the partition can adjust the luminous energy and a traveling direction of light emitted from the flasher bulb.

In other words, the headlight apparatus attains adjustment of the luminous energy and the traveling direction of the light emitted from the flasher bulb without applying a work on the inner surface of the flasher lens.

A second aspect of the invention is that the directional indicator is adjacent to the headlight. The headlight has a headlight lens that is formed with the directional indicator lens in one unit.

A third aspect of the invention is that the partition has a plate portion having a geometry of a substantially flat plate.

A fourth aspect of the invention is that the partition has a plurality of plate portions.

A fifth aspect of the invention is that the partition has an outer frame portion that supports the plurality of plate portions.

A sixth aspect of the invention is that an optical axis of the light source extends obliquely forwardly from the vehicle to which the headlight apparatus is attached.

A seventh aspect of the invention is a vehicle that has the headlight apparatus.

According to the present invention, a headlight apparatus for a vehicle that allows adjustment of the luminous energy and a traveling direction of light emitted from a flasher bulb without applying a machining on an inner surface of a flasher lens is provided.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a left side view of a motorcycle according to an embodiment of the present invention.

FIG. 2 is a front view of a handlebar assembly including a headlight unit according to the embodiment of the present invention.

FIG. 3 is an exploded perspective view of the headlight unit according to the embodiment of the present invention.

FIG. 4 is a plan view of the headlight unit according to the embodiment of the present invention.

FIG. 5 is a cross-sectional view taken along line F5-F5 of FIG. 4.

### DETAILED DESCRIPTION OF THE INVENTION

### Configuration of Vehicle According to Present Embodiment

An embodiment of a vehicle according to the present invention is now described with reference to the drawings. In the following description and drawings, identical or similar parts are denoted by identical or similar reference numerals. It should also be noted that the drawings are schematic diagrams, and may represent different dimensional ratios and the like from those of the actual apparatus.

Hence, specific dimensions and the like should be determined in consideration of the following description. Furthermore, as a matter of course, different drawings include elements which have different dimensional relations and ratios.

(1) General Configuration

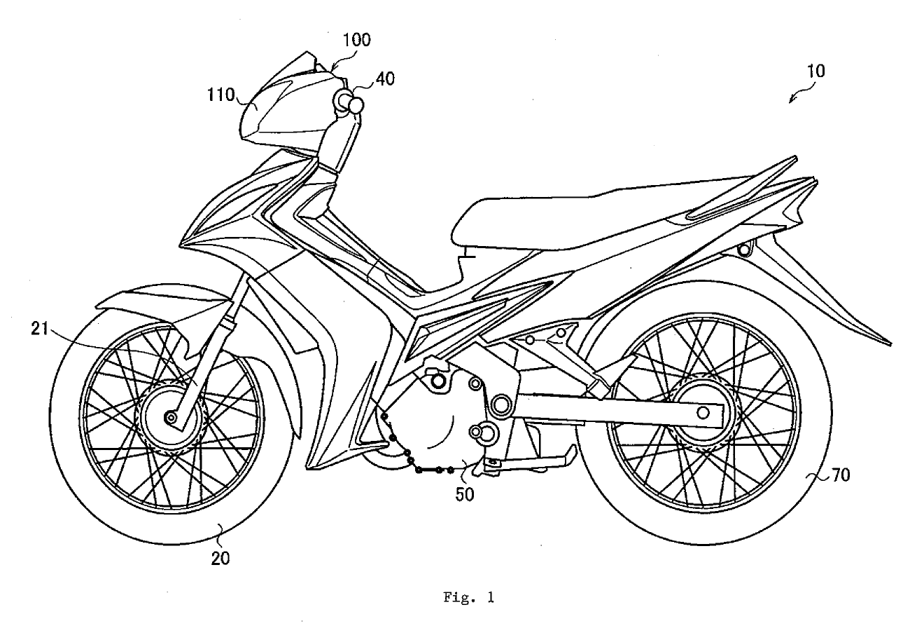

FIG. 1 is a left side view of a motorcycle 10. Motorcycle 10 is a so-called underbone-type motorcycle having a body frame disposed at a lower position as compared with that of a general straddle-type motorcycle.

Motorcycle 10 has a front wheel 20 and a rear wheel 70. An engine 50 generates a driving force that drives rear wheel 70.

Motorcycle 10 has a pair of left and right front forks 21 that rotatably support front wheel 20. Specifically, front forks 21 move (in a linear motion) front wheel 20 vertically (in practice, in a direction along which a predetermined caster angle is provided) in accordance with changes in road conditions, to thereby absorb a shock received on front wheel 20.

A handlebar assembly 100 is disposed above front forks 21. Handlebar assembly 100 includes a handlebar 40 to be manipulated by a rider to steer front wheel 20, and a headlight unit 110.

(2) Configuration of Headlight Apparatus

Next, the configuration of headlight unit 110 that forms the headlight apparatus in this embodiment will be described.

(2.1) Overall Configuration

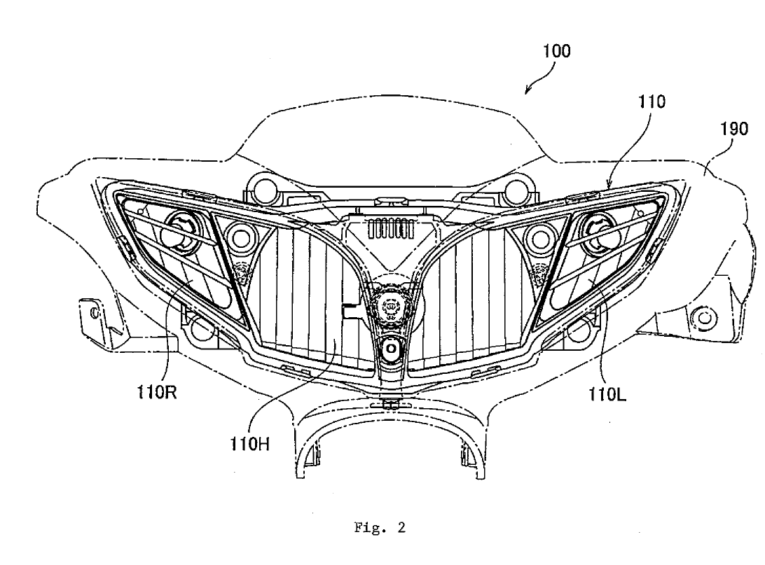

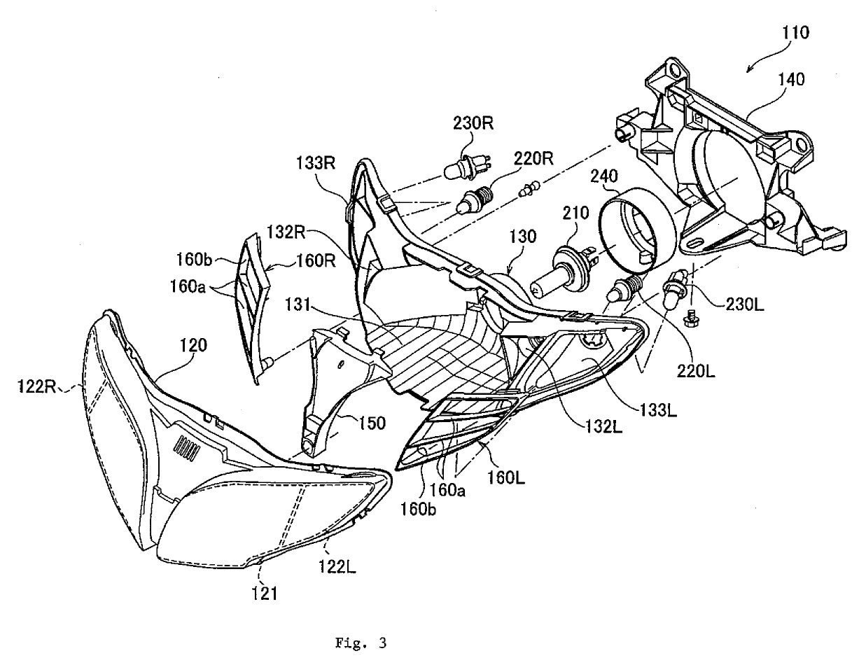

FIG. 2 is a front view of handlebar assembly 100 including headlight unit 110. FIG. 3 is an exploded perspective view of headlight unit 110.

As shown in FIG. 2, handlebar assembly 100 has headlight unit 110 and a handlebar cover 190 that surrounds headlight unit 110.

Headlight unit 110 includes a headlight section 110H and a flasher section 110L, 110R. Flasher section 110L, 110R forms a directional indicator. Flasher section 110L, 110R is adjacent to headlight section 110H.

Headlight unit 110 has a headlight lens 121 (see FIG. 3). Flasher section 110L (110R) has a flasher lens 122L (122R) (see FIG. 3).

As shown in FIG. 3, headlight unit 110 has a front lens 120, a headlight body 130, and a headlight bracket 140.

Front lens 120 is made of a transparent synthetic resin. Front lens 120 is formed with headlight lens 121 and a flasher lens 122L, 122R. Specifically, headlight lens 121 and flasher lens 122L, 122R are formed in one unit.

Headlight lens 121 is disposed forward of a headlight bulb 210. Flasher lens 122L (122R) is disposed forward of a flasher bulb 230L (230R). Flasher lens 122L (122R) forms a directional indicator lens, and flasher bulb 230L (230R) forms a light source.

Headlight body 130 includes a headlight reflector 131, a position-lamp reflector 132L, 132R, and a flasher reflector 133L, 133R.

Reflector 131 reflects light emitted from headlight bulb 210 attached to reflector 131.

Reflector 132L (132R) reflects light emitted from a position lamp 220L (220R) attached to reflector 132L (132R).

Position lamp 220L (220R) causes other vehicles and the like to recognize the position of motorcycle 10. The luminous energy of position lamp 220L, 220R is lower than the luminous energy of headlight bulb 210. Reflector 132L (132R) and position lamp 220L (220R) are placed on the outside of reflector 131 and headlight bulb 210.

Reflector 133L (133R) reflects light emitted from flasher bulb 230L (230R) attached to reflector 133L (133R).

When changing the traveling direction of motorcycle 10 is intended, flasher bulb 230L (230R) flashes at predetermined intervals to indicate the traveling direction of motorcycle 10 (right or left). Flasher bulb 230L (230R) is attached to reflector 133L (133R) provided on the outside of reflector 132L (132R). Reflector 133L (133R) and flasher bulb 230L (230R) are disposed on the outside of reflector 132L (132R) and position lamp 220L (220R).

Headlight bracket 140 supports front lens 120 and headlight body 130 for vertical movement; that is, to be capable of adjusting its aiming. In addition, headlight bracket 140 is fixed to handlebar cover 190.

A light-shielding wall 150 is disposed between front lens 120 and headlight body 130. A louver 160L is disposed to the left side of light-shielding wall 150. A louver 160R is disposed to the right side of light-shielding wall 150.

Light-shielding wall 150 shields light emitted from headlight bulb 210 and light reflected from reflector 131. Light-shielding wall 150 is disposed between front lens 120 and reflector 131, and between front lens 120 and headlight bulb 210.

Louver 160L (160R) partitions flasher lens 122L (122R). Louver 160L (160R) of this embodiment forms a partition. Louver 160L (160R) is formed of a material (an opaque resin) that can shield light emitted from flasher bulb 230L (230R).

Louver 160L (160R) has plate portions 160a with a geometry of substantially flat plates. Specifically, louver 160L (160R) has two plate portions 160a. Louver 160L (160R) also has an outer frame portion 160b that supports plate portions 160a.

In this embodiment, plate portions 160a are disposed along the longitudinal direction of headlight unit 110; that is, along the widthwise direction of the vehicle.

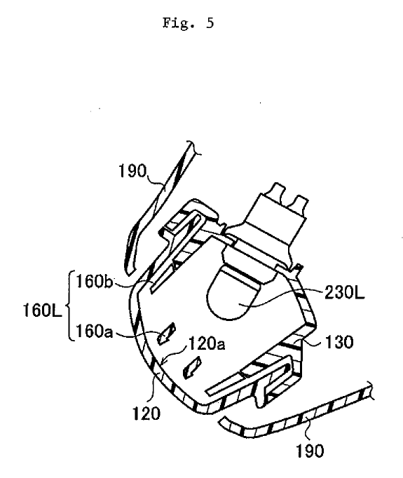

Louver 160L (160R) is disposed between front lens 120 and headlight body 130. Specifically, louver 160L (160R) is disposed between flasher lens 122L (122R) and reflector 133L (133R). More specifically, louver 160L (160R) is disposed on an inner surface 120a (see FIG. 5) of flasher lens 122L (122R).

A socket cover 240 that covers a base (not shown) of headlight bulb 210 is attached to the rear of headlight body 130.

(2.2) Arrangement of Partition and Light Source

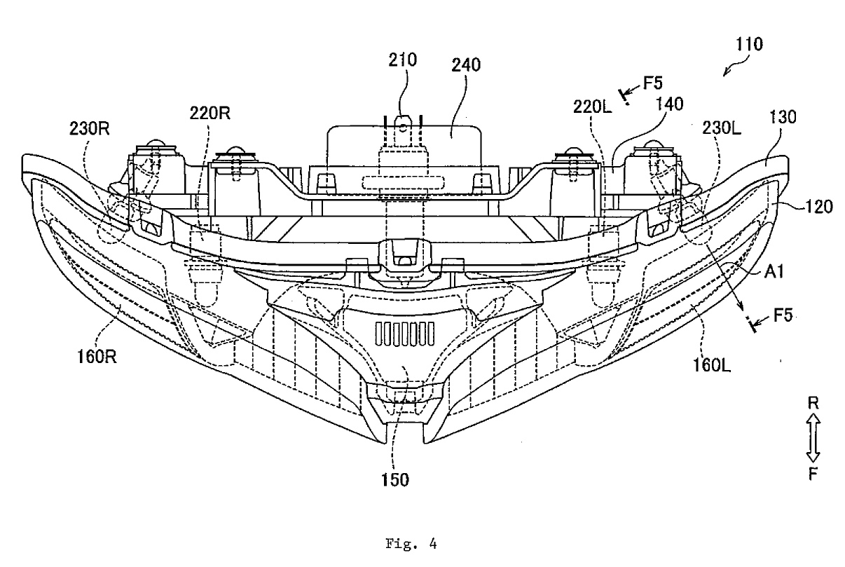

Next, referring to FIGS. 4 and 5, the arrangement of louver 160L (160R) that forms the partition, and flasher bulb 230L (230R) that forms the light source, will be described.

As shown in FIG. 4, an optical axis A1 of flasher bulb 230L is oriented to extend obliquely forwardly from motorcycle 10 while headlight unit 110 is attached to motorcycle 10. Flasher bulb 230R is disposed in substantially symmetrical relation to flasher bulb 230L.

Specifically, optical axis A1 extends to obliquely intersect the F·R (fore-and-aft) direction in the drawing. In other words, optical axis A1 is outwardly oriented as compared with the fore-and-aft direction of motorcycle 10.

FIG. 5 is a cross-sectional view taken along line F5-F5 of FIG. 4. As shown in FIG. 5, louver 160L is disposed inside front lens 120; specifically, inside flasher lens 122L. More specifically, louver 160L is disposed on inner surface 120a of flasher lens 122L.

Flasher bulb 230L attached to headlight body 130 (specifically, reflector 133L) is located to the rear of louver 160L Handlebar cover 190 covers front lens 120 from above and below front lens 120.

(Function and Effects)

In headlight unit 110, louver 160L (160R) that partitions flasher lens 122L (122R) is disposed on inner surface 120a of flasher lens 122L (122R). Hence, louver 160L (160R) attains adjustment of the luminous energy and the traveling direction of the light emitted from flasher bulb 230L (230R).

In other words, headlight unit 110 attains adjustment of the luminous energy and the traveling direction of the light emitted from flasher bulb 230L (230R) without applying a machining; e.g., forming predetermined projections and depressions, on the inner surface of flasher lens 122L (122R).

Since louver 160L (160R) is disposed on inner surface 120a of flasher lens 122L (122R), louver 160L (160R) can be located closer to flasher bulb 230L (230R) as compared with a configuration in which louver 160L (160R) is disposed on the outer surface (not shown) of flasher lens 122L (122R).

Hence, adjustment of the luminous energy and the traveling direction of light emitted from flasher bulb 230L (230R) is attained easily. In addition, headlight unit 110; specifically, flasher section 110L (110R), can be reduced in longitudinal size. Furthermore, since louver 160L (160R) can be located close to flasher bulb 230L (230R), adjustment of the luminous energy and the traveling direction of light emitted from flasher bulb 230L (230R) is attained effectively while reducing louver 160L (160R) in size.

Furthermore, since louver 160L (160R) is disposed on inner surface 120a of flasher lens 122L (122R), louver 160L (160R) is protected from dirt and damage as compared with a configuration in which louver 160L (160R) is disposed on the outer surface of flasher lens 122L (122R). Improvement of louver 160L (160R) in weatherability is also attained.

In this embodiment, headlight lens 121 and flasher lens 122L, 122R are formed integrally. Hence, headlight unit 110 that includes headlight section 110H and flasher section 110L, 110R is enhanced in that it is an integrated element.

In this embodiment, louver 160L (160R) has the plurality of plate portions 160a. Hence, adjustment of the luminous energy and the traveling direction of the light emitted from flasher bulb 230L (230R) is attained more easily and reliably.

In addition, louver 160L (160R) has outer frame portion 160b that supports plate portions 160a. Hence, attachment of louver 160L (160R) having plate portions 160a to headlight body 130 is facilitated.

In this embodiment, optical axis A1 of flasher bulb 230L (230R) is oriented to extend obliquely forwardly from motorcycle 10 while headlight unit 110 is attached to motorcycle 10. In this manner, flashing of flasher bulb 230L (230R) can be visually recognized even from an obliquely frontward direction of motorcycle 10 without fail.

### OTHER EMBODIMENTS

While an embodiment of the invention has been described, it should be understood that the description and the drawings forming a part of this disclosure do not limit the scope of this invention. Alternative embodiments based on the disclosure will be apparent to those skilled in the art.

For example, in the aforementioned description, optical axis A1 of flasher bulb 230L (230R) is oriented to extend obliquely forwardly from motorcycle 10. However, optical axis A1 of flasher bulb 230L (230R) is not necessarily oriented to extend obliquely forwardly.

In the aforementioned description, louver 160L (160R) has outer frame portion 160b. However, louver 160L (160R) may not have outer frame portion 160b.

In the aforementioned description, louver 160L (160R) has two plate portions 160a. However, the number of plate portions 160a may be other than two. In addition, plate portions 160a may be of a rod shape (a round rod or an angular rod shape). Furthermore, while plate portions 160a are described as disposed along the widthwise direction of the motorcycle, plate portions 160a may be disposed along the vertical direction of motorcycle 10.

The invention includes other embodiments that are not described in this document. The technical scope of the invention is defined only by the appended claims.

1. A headlight apparatus comprising a headlight and a directional indicator, wherein the directional indicator includes:
a light source that flashes at predetermined intervals;
a directional indicator lens disposed forward of the light source; and
a partition for partitioning the directional indicator lens, wherein the partition is disposed on an inner surface of the directional indicator lens.

2. The headlight apparatus according to claim 1, wherein:
the directional indicator is adjacent to the headlight;
the headlight has a headlight lens; and
the directional indicator lens and the headlight lens are formed in one unit.

3. The headlight apparatus according to claim 1, wherein the partition comprises a plate portion having a geometry of a substantially flat plate.

4. The headlight apparatus according to claim 3, wherein the partition comprises a plurality of the plate portions.

5. The headlight apparatus according to claim 4, wherein the partition further comprises an outer frame portion that supports the plurality of plate portions.

6. The headlight apparatus according to claim 1, wherein an optical axis of the light source is oriented to extend obliquely forwardly from the vehicle while the headlight apparatus is attached to the vehicle.

7. A vehicle comprising the headlight apparatus of claim 1.
